(19) United States
(12) Patent Application Publication
(10) Pub. No.: US 2014/0192679 A1
(43) Pub. Date: Jul. 10, 2014

(54) Convergent Network Node with the Automatic Reconfiguration Capability

(71) Applicants: TATUNG COMPANY, Taipei (TW); STMICROELECTRONICS, INC., Coppell, TX (US)

(72) Inventors: Oleg Logvinov, East Brunswick, NJ (US); Tai-Jee Pan, Beaverton, OR (US)

(21) Appl. No.: 14/150,576

(22) Filed: Jan. 8, 2014

Related U.S. Application Data
(60) Provisional application No. 61/750,178, filed on Jan. 8, 2013.

(51) Int. Cl. H04W 48/20; H04B 3/54

(52) U.S. Cl. CPC H04W 48/20; H04B 3/544
USPC 370/254

(57) ABSTRACT

An embodiment is a portable in-home display/controller device including a power line communication interface providing two-way communication over a power line communication medium, a wireless communication interface providing two-way communication over a wireless network, and a docking station configured to receive the portable in-home display/controller for connection to the power line communication medium. The wireless communication interface provides access point functionality when the in-home display/controller device is docked to the docking station and connects to a communication network via the power line communication interface. The in-home display/controller device is configured to automatically, without operator intervention, function as a wireless client when it is removed from the docking station.

This application claims the benefit of U.S. Provisional Application Ser. No. 61/750,178, filed on Jan. 8, 2013, entitled “Convergent Network Node with the Automatic Reconfiguration Capability,” which application is hereby incorporated herein by reference.

### BACKGROUND

In today's Smart Home environment the interaction with the user and the ability to identify the user is becoming more and more important. At the same time, the importance of constant “on” wireless connectivity is increasing as well. In-home displays and in-home controllers are common devices that provide a user access to information or control from any location in the home. An example is a thermostat controller or a lighting controller. The controller may display status information such as temperature and filter life, status of lights, or the like. It may also be able to control temperature and/or schedule when certain temperatures should be maintained, or report the temperature at its location. In a Smart Grid example, the In-home display/controller may indicate the status of an Electric Vehicle (EV) that is charging in the garage, the cost of energy, or other information from the utility provider, etc. An example of the Smart Grid control function includes setting the conditions for when an appliance will operate (for example, setting a dishwasher to run at 3 AM, or when the utility reduces its energy cost below a specific range). Data that is used to control devices is referred to as control data. It is clear that the home of the future will see a combination of dedicated in-home displays/controllers and apps that reside on tablets and smart phones. Improvements to the art are needed to adequately adapt to such technologies.

### SUMMARY OF THE INVENTION

An embodiment is a portable in-home display/controller device including a power line communication interface providing two-way communication over a power line communication medium, a wireless communication interface providing two-way communication over a wireless network, and a docking station configured to receive the portable in-home display/controller for connection to the power line communication medium. The wireless communication interface provides access point functionality when the in-home display/controller device is docked to the docking station and connects to a communication network via the power line communication interface. The in-home display/controller device is configured to automatically, without operator intervention, function as a wireless client when it is removed from the docking station.

Another embodiment is a method of communicating, the method including determining a presence of a wired communication media, determining whether the wired communication media satisfies a criterion, and in response to determining the wired communication media does satisfy the criterion, configuring a wireless communication interface to function as a wireless access point, and communicating over the wired communication media. The method further includes in response to determining the wired communication media does not satisfy the criterion, configuring the wireless communication interface to function as a wireless client.

A further embodiment is a device including a docking station interface, a wireless communication interface, a user interface, wherein the docking station interface includes an interface for communicating information over a wired communication network, and wherein the wireless communication interface includes functionality to operate as a wireless access point and functionality to operate as a wireless client. The device further configured to automatically switch, without requiring user input, between operating the wireless communication interface as the wireless access point and operating the wireless communication interface as the wireless client in response to detecting a condition.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a block diagram of a system according to an illustrative embodiment; and

FIG. 2 is a process flow diagram of an example process of operating the system according to an illustrative embodiment.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosed subject matter, and do not limit the scope of the different embodiments.

Embodiments of the present invention provide a novel method and system that combines wired and wireless connectivity, allowing for automatic creation of wireless access points via a combination of wired and wireless interfaces on the same device. Such an approach can be applied to many devices, and in particular to in-home displays.

In general terms, using embodiments of the present invention, devices, such as dedicated in-home displays/controllers, can leverage both wired and wireless interfaces for connecting and communicating with other devices/networks. If the device is permanently installed or placed in a docking station, both the wireless and the wired interfaces are available from/to it. However, if the device is undocked, only the wireless interface would be accessible from/to the device. In some embodiments, docked/wired devices can also serve as wireless access points if the wired communication is available. In some embodiments, both the docking station and the device can serve as wireless access points depending on the needs of the system. By enabling the device to become a wireless access point while docked and to act as a wireless client when undocked, both the issues of pervasive connectivity and the need for additional access points within the home are solved.

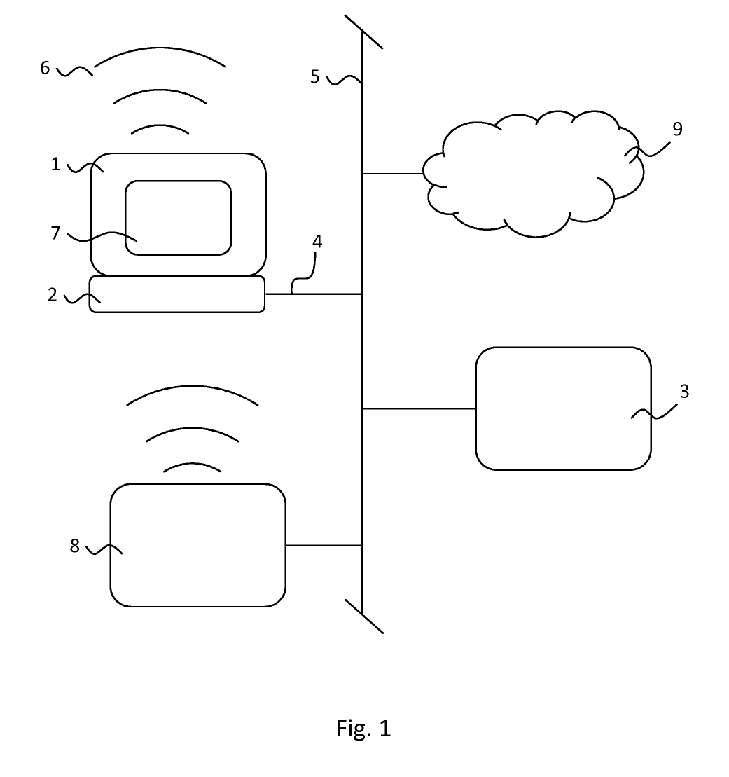

FIG. 1 illustrates a block diagram of an illustrative embodiment of a system including a device 1 has at least two communication interfaces, such as a wired interface 4 and a wireless interface 6. The device 1 further includes a user interface 7. The system further includes another device 3, a wireless access point 8, and one or more networks in the cloud 9 (e.g. the Internet). In some embodiments, each of these devices/networks may be connected via a wired media 5. In some embodiments, at least one of these devices may be connected to the other devices via a wireless media using, for example, the wireless interface 6 and/or wireless access point 8.

In some embodiments, the device 1 is an in-home display/controller (IHD/C) and is referred to as IHD/C 1 hereinafter. When the IHD/C 1 is installed in a docking station 2 on a wall or some other surface, the IHD/C 1 is connected through both the wired interface 4 and the wireless interface 6. In some embodiments, both the IHD/C 1 and the docking station 2 may have a wireless interface. In the illustrated embodiment, IHD/C 1 may communicate via the wired interface 4 to the device 3, such as a smart energy controller/meter 3, directly, or to any other system or device through the cloud 9. In some embodiments, this wired interface 4 may utilize, for example, a wired media 5 such as a power line communication (PLC) connection.

In the PLC connection embodiment, the wired media 5 is an alternating current (AC) power line 5. The devices coupled to AC power line 5 (e.g. devices 1, 3, and 8, and cloud 9) may communicate with each other over the power line 5. In some embodiments, any number of IHD/Cs 1, or other devices (e.g. devices 3 or 8), may be coupled to the power line 5, and that any number of other device types may also be coupled to the power line 5 other than those shown in FIG. 1. For example, the system illustrated in FIG. 1 could include lighting nodes, networked appliances, a heating, ventilation, and air conditioning (HVAC) system, a local controller (such as a user terminal), a power meter, a solar panel/solar panel controller, and an energy storage device, such as a battery. In an embodiment, this energy storage device may be an EV that may consume power from AC power line 5 during some time periods, or make power available to AC power line 5 during other periods of time. It should be appreciated that in further alternative embodiments, the power line 5 may be implemented using a DC power line, non-energized wires, or other suitable power distribution types including wireless power.

For example, the PLC connection may use a PLC network such as IEEE 1901, IEEE P1901.2, HomePlug GP/AV/AV2/1.0, G.hn, G.hnem, and other similar technologies. In other embodiments, the wired media could be a standard network cable and may utilize a connection such as Fast Ethernet. The wireless interface 6 may utilize, for example, a Wi-Fi connection such as specified by the IEEE 802.11 series of standards and are incorporated herein by reference, a ZigBee connection as specified by IEEE 802.15.4 series of standards and are incorporated herein by reference, a Bluetooth connection, a cellular connection, or connections of other suitable wireless technologies.

In an embodiment, the docking station 2 may have the PLC interface to the power line 5 and the IHD/C 1 may communicate with the docking station through another protocol, such as universal serial bus (USB), a proprietary protocol, the like, or any other suitable communication protocol. In another embodiment, the IHD/C 1 may have the PLC interface and the docking station 2 may act as a pass-through device between the power line 5 and the IHD?C 1, and, in other embodiments, both the docking station 2 and the IHD/C 1 have PLC interfaces. Although the embodiments in this paragraph described a PLC interface and power line 5, the embodiments are not limited only to PLC interfaces and power line 5, as the interfaces in both of the IHD/C 1 and the docking station 2 may be any of interfaces previously listed above and the power line 5 can be any suitable wired media 5 listed above.

When the IHD/C 1 is removed from the docking station 2, it automatically, without use of the user interface 7 or any other user directed input, modifies its functionality to become a wireless client via the wireless interface 6. In a preferred embodiment, the IHD/C 1 determines that it is removed from the docking station 2 when it detects that the wired interface 4 no longer functions or is significantly degraded. The wireless interface 6 may then connect directly to the relevant devices or systems 3, the Internet, or other network in the cloud 9 via the alternative wireless access point 8 located in the local area network. In an embodiment, the docking station 2 may act as a wireless access point through a wireless interface (not shown in FIG. 1) in the docking station 2, which may provide wireless access to the IHD/C 1 through the wireless interface 6 when the IHD/C 1 is undocked. In some embodiments, the IHD/C 1 determines that it is removed from the docking station 2 by other means such as an IHD/C 1 presence switch (e.g. a contact switch, a magnetic switch, an optical switch, or the like), detecting the status of the wired or wireless charging of the IHD/C 1, or the like. In the illustrated embodiment, the wireless access point 8 is a stand-alone device located external to the IHD/C 1 and external to the device 3. In other embodiments, wireless access point 8 could be incorporated into one of these devices or into some other device, such as an appliance.

In some embodiments, the IHD/C 1 determines whether the wired interface 4 via the wired media 5 satisfies one or more criteria for the communication of the IHD/C 1. In an embodiment, the criteria for the communication of the device 1 over the wired media 5 includes quality of service (QoS) for the communication, a signal to noise ratio for the communication, a channel capacity for the communication, packet loss, additional factors that could be representative of the condition of the channel, the like, or a combination thereof. In some embodiments, the criteria for the communication of the device 1 over the wired media 5 includes a status of the connection (e.g. active, inactive, failed, restored, or the like) for each of wired and/or wireless interfaces, user configurable settings, or other suitable for criteria for choosing the appropriate interface.

If the IHD/C 1 determines that the wired interface 4 does satisfy the one or more criteria for the communication of the IHD/C 1, then it does not need the wireless interface 6 for connection to the other devices 3 and 8 and/or other network in the cloud 9. In this scenario, the IHD/C 1 can use the wired interface 4 for communication and the wireless interface 6 of the IHD/C 1 can configure itself to become a wireless access point to provide wireless communication for other devices/networks not shown in FIG. 1.

If the IHD/C 1 determines that the wired interface 4 does not satisfy the one or more criteria for the communication of the IHD/C 1, then it does need the wireless interface 6 for connection to the other devices 3 and 8 and/or other network in the cloud 9. In this scenario, the wireless interface 6 of the IHD/C 1 can configure itself to become a wireless client and communicate with the other devices/networks (e.g. devices 3 and 8, other network in the cloud 9, and/or other devices/networks not shown in FIG. 1) using the wireless interface 6 via an alternative wireless access point 8. In an embodiment, the wireless interface 6 incorporates a Wi-Fi connection interface 6 into the IHD/C 1. In an embodiment, the wired interface 4 uses HomePlug or another suitable power line communication technology.

In some embodiments, the IHD/C1 includes a battery and it takes into account the state of the state of the battery (e.g. charging/discharging, remaining capacity, etc.) when selecting the appropriate communication interface (wired interface 4 or wireless interface 6). For example, one of the communications interfaces may consume less power than the other communication interface and it may be selected when the remaining capacity of the battery is low. In these embodiments, the IHD/C 1 can take into account both the state of the battery and the state of the communication interfaces when determining the appropriate communication interface. The IHD/C 1 may have additional operational settings such as frame rate, display refresh rate, display intensity, and display resolution that can also be used to minimize battery usage consumption and may affect the communication interfaces. These operational settings may be automatically configured and controlled by the IHD/C 1 or may be manually controlled and/or overridden by a user.

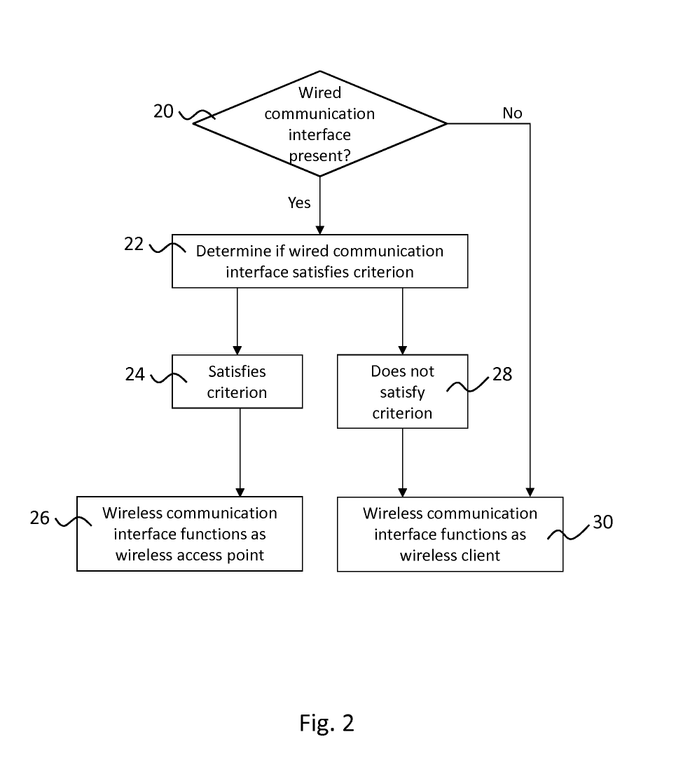

FIG. 2 is a process flow diagram of an example process of operating the system according to an illustrative embodiment. In step 20, the device determines whether the wired communication interface is present. If the wired communication interface is not present, the wireless communication interface functions as a wireless client (step 30). If the wired communication interface is present, in step 22, the device determines if the wired communication interface satisfies a criterion of the communication for the device. In some embodiments, the step 20 may be omitted, as the presence of the wired communication interface may also be determined in step 22. If the wired communication interface does satisfy the criterion (step 24), then the wireless communication interface functions as a wireless access point, in step 26. If the wired communication interface does not satisfy the criterion (step 28), the wireless communications interface functions as a wireless client, in step 30.

The present disclosure can extend equally to encompass embodiments including whole house speaker nodes, LED lights, visible light communication devices, a camera, a video camera, such as a surveillance video camera, and the like.

A preferred embodiment uses IEEE 1905.1, incorporated herein by reference, as the media abstraction layer, which helps the node to obtain the state of a specific media and the quality of available links.

The following U.S. patents and U.S. Patent Application Publication are incorporated herein by reference in their entirety: U.S. Pat. No. 7,440,443, entitled “Integrated universal network adapter;” U.S. Pat. No. 8,050,287, entitled “Integrated universal network adapter;” and U.S. Patent Application Publication 2013-0121157 A1, entitled “System and Method for an Energy Efficient Network Adapter.” In particular, these patents and patent publication describe the criteria to satisfy the communication of the device 1 and other criteria as well as other methods of determining network status/functionality. Such concepts may also be applied to embodiments herein.

By having the devices switch from wireless clients to wireless access points automatically depending on a set of criteria, the devices can have pervasive and robust connectivity without any input from the user, while allowing for flexibility in operation and implementation. Further advantages of the embodiments include fulfilling the need for additional wireless access points throughout a home or business without the need to acquire or setup additional access points.

Although the present embodiments and their advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A portable in-home display/controller device comprising:
a power line communication interface providing two-way communication over a power line communication medium;
a wireless communication interface providing two-way communication over a wireless network;
a docking station configured to receive the portable in-home display/controller for connection to the power line communication medium;
wherein the wireless communication interface provides access point functionality when the in-home display/controller device is docked to the docking station and connects to a communication network via the power line communication interface; and
wherein the in-home display/controller device is configured to automatically, without operator intervention, function as a wireless client when it is removed from the docking station.

2. The device of claim 1, wherein the power line communication medium is part of a home area network and is compliant with HomePlug standards.

3. The device of claim 1, wherein the power line communications medium is part of a home area network and is compliant with IEEE 1901 standards.

4. The device of claim 1, wherein the wireless network is a Wi-Fi compatible network.

5. The device of claim 1, wherein the wireless network is also part of a home area network.

6. The device of claim 1, wherein the power line communication medium is electrical distribution wiring.

7. The device of claim 1, wherein the power line communication medium includes dedicated electrical wiring.

8. The device of claim 1, wherein the in-home display/controller device is further configured to automatically, without operator intervention, function as the wireless client when it detects that the power line communication medium is insufficient for desired communication.

9. The device of claim 1, wherein the docking station is further configured to charge the portable in-home display/controller.

10. A method of communicating, the method comprising:
determining a presence of a wired communication media;
determining whether the wired communication media satisfies a criterion;
in response to determining the wired communication media does satisfy the criterion, configuring a wireless communication interface to function as a wireless access point, and communicating over the wired communication media; and
in response to determining the wired communication media does not satisfy the criterion, configuring the wireless communication interface to function as a wireless client.

11. The method of claim 10, wherein the criterion is the presence of the wired communication media.

12. The method of claim 10, wherein the criterion is a quality of service level for communication over the wired communication media.

13. The method of claim 10, wherein the criterion is a signal to noise ratio for communication over the wired communication media.

14. A device comprising:
a docking station interface;
a wireless communication interface;
a user interface;
wherein the docking station interface includes an interface for communicating information over a wired communication network;
wherein the wireless communication interface includes functionality to operate as a wireless access point and functionality to operate as a wireless client; and
wherein the device is configured to automatically switch, without requiring user input, between operating the wireless communication interface as the wireless access point and operating the wireless communication interface as the wireless client in response to detecting a condition.

15. The device of claim 14, wherein the condition is detecting the presence of a docking station connected to the docking station interface.

16. The device of claim 14, wherein the condition is detecting the presence of a wired communication media connected to the docking station.

17. The device of claim 14, wherein the condition is detecting a quality of communication over a wired communication media connected to the docking station.

18. The device of claim 14 further comprising the docking station.

19. The device of claim 18 further comprising a wired communication media connected to the docking station and wherein the wired communication media is a power line.

20. The device of claim 19, wherein the power line is part of a power line communication network.

21. The device of claim 14, wherein the wireless communication interface is configured to operate as the wireless access point when the device is connected to a docking station and configured to operate as the wireless client with the device is not connected to the docking station.

22. The device of claim 14, wherein the device operates as a home display/controller.
